(19) United States
(12) Patent Application Publication
(10) Pub. No.: US 2020/0055503 A1
(43) Pub. Date: Feb. 20, 2020

(54) Control Device for Electric Vacuum Pump, and Method for Controlling Electric Vacuum Pump

(71) Applicant: Daimler AG, Stuttgart (DE)

(72) Inventor: Wenshan TANG, Kawasaki (JP)

(73) Assignee: Daimler AG, Stuttgart (DE)

(21) Appl. No.: 16/474,351

(22) PCT Filed: Nov. 17, 2017
(86) PCT No.: PCT/JP2017/041391

§ 371 Date: Jun. 27, 2019

(30) Foreign Application Priority Data
Dec. 28, 2016 (JP) 2016-256997

(51) Int. Cl. B60T 8/40; B60T 13/52

(52) U.S. Cl. CPC B60T 8/40; B60T 13/662; B60T 13/52

(57) ABSTRACT

A control device for an electric vacuum pump that generates a negative pressure includes a negative-pressure detector for detecting the negative pressure generated by the electric vacuum pump and a pump stop control unit that is adapted to stop the electric vacuum pump when the negative pressure detected by the negative-pressure detector is not less than a predetermined value. The pump stop control unit is configured to determine an OFF timing at a present stage of the electric vacuum pump based on reference pump-filling-performance data, which is data about a reference negative pressure ratio relative to an elapsed time at an initial stage of the electric vacuum pump, and by referring to present pump-filling-performance data, which is data about a present negative pressure ratio relative to an elapsed time at the present stage of the electric vacuum pump.

### FIELD OF THE INVENTION

The present disclosure relates to a control device for an electric vacuum pump and a method for controlling an electric vacuum pump.

More specifically, the present disclosure relates to a control device for an electric vacuum pump that generates a negative pressure in a brake booster, which is mounted, for example, on an electric vehicle (EV), and to a method for controlling the electric vacuum pump.

### BACKGROUND OF THE INVENTION

Conventionally, vehicles, such as automobiles, equipped with an internal combustion engine, for example, an engine, are designed to drive a vacuum pump (a mega pump, which is a mechanical pump) by a rotational driving force produced by the engine, as disclosed in Patent Document 1 (Japanese Unexamined Patent Application Publication No. 2003-102146).

This mechanism generates a negative pressure for a brake booster that assists in reducing a driver's brake operating force and serves as a boosting device for a brake.

Meanwhile, in recent years, electric vehicles have been widely used in terms of limited resources, environmental friendliness, etc. Such an electric vehicle, which does not have an internal combustion engine, is not provided with a mega pump that uses the rotation of the engine. Thus, to generate a negative pressure in the brake booster, it is necessary to provide an electric vacuum pump dedicated to electric vehicles, in place of the mega pump.

In this case, an electric motor that is configured as part of the electric vacuum pump has a limited lifetime due to wear and damage of a rotational part, such as a brush. For this reason, the electric motor of the electric vacuum pump cannot be operated constantly, unlike the mega pump.

Therefore, for this kind of electric vacuum pump, a control method for shortening the operating time of the electric vacuum pump is conventionally performed. Specifically, under a certain negative pressure (negative pressure ratio), an ON threshold is set as a negative pressure for activating the electric vacuum pump. On the other hand, once the predetermined negative pressure (negative pressure ratio) is reached, a threshold (OFF threshold) is set as a negative pressure for stopping the electric vacuum pump. In this way, measures are taken to delay the degradation of the electric vacuum pump and thereby extend its lifetime.

### RELATED ART DOCUMENT

### [Patent Document]

### [Patent Document 1] Japanese Unexamined Patent Application Publication No. 2003-102146

### SUMMARY OF THE INVENTION

In the use of the electric vacuum pump when a relatively low negative pressure ratio is required, for example, in passenger vehicles, such a conventional control method for the electric vacuum pump can satisfy the required pump performance (pump-filling-performance) while extending the lifetime of the electric vacuum pump.

However, commercial vehicles, for example, trucks and buses, require a relatively higher negative pressure ratio than passenger vehicles.

Thus, when using the electric vacuum pump in a commercial vehicle, if an OFF threshold is set at a relatively low negative pressure ratio, like a passenger vehicle, in order to achieve the desired long lifetime of an electric vacuum pump, a high pump performance requirement (pump-filling-performance) cannot be satisfied in dispatching the commercial vehicle.

On the other hand, if an OFF threshold is set at a relatively high negative pressure ratio based on the high pump performance requirement (pump-filling-performance) that is required to dispatch a commercial vehicle, the operating time might be long, failing to ensure sufficient pump lifetime.

Therefore, when using the electric vacuum pump in a commercial vehicle, there is a trade-off between the achievement of the high pump performance requirement (pump-filling-performance) in dispatching and the extension of the lifetime of the pump, so that both conditions cannot be achieved simultaneously.

In view of the foregoing circumstances, at least one embodiment of the present invention has an object to provide a control device for an electric vacuum pump and a method for controlling an electric vacuum pump that can extend the lifetime of the electric vacuum pump while improving the performance of the electric vacuum pump.

Furthermore, some embodiments have another object to provide a control device for an electric vacuum pump and a method for controlling an electric vacuum pump that can simultaneously achieve both the pump performance requirement in dispatching and the long lifetime of the pump in commercial vehicles, which are electric vehicles with no internal combustion engine.

The present invention has been made to solve the problems in the related art and to achieve the objects mentioned above. According to at least one aspect of the present invention, a control device for an electric vacuum pump that generates a negative pressure is provided which includes:

a negative-pressure detector for detecting the negative pressure generated by the electric vacuum pump; and

a pump stop control unit that is adapted to stop the electric vacuum pump when the negative pressure detected by the negative-pressure detector is not less than a predetermined value, wherein

the pump stop control unit is configured to determine an OFF timing at a present stage of the electric vacuum pump

based on reference pump-filling-performance data, which is data about a reference negative pressure ratio relative to an elapsed time at an initial stage of the electric vacuum pump, and

by referring to present pump-filling-performance data, which is data about a present negative pressure ratio relative to an elapsed time at the present stage of the electric vacuum pump.

According to some embodiments, a method for controlling an electric vacuum pump that generates a negative pressure is provided which includes:

a negative-pressure detection step of detecting the negative pressure generated by the electric vacuum pump; and

a pump stop control step of stopping the electric vacuum pump when the negative pressure detected by a negative-pressure detector is not less than a predetermined value, wherein

the pump stop control step determines an OFF timing at a present stage of the electric vacuum pump

based on reference pump-filling-performance data, which is data about a reference negative pressure ratio relative to an elapsed time at an initial stage of the electric vacuum pump, and

by referring to present pump-filling-performance data, which is data about a present negative pressure ratio relative to an elapsed time at the present stage of the electric vacuum pump.

With this arrangement, the OFF timing at the present stage of the electric vacuum pump is determined based on the reference pump-filling-performance data, which is data about the reference negative pressure ratio relative to the elapsed time at the initial stage (in dispatching) of the electric vacuum pump, and by referring to the present pump-filling-performance data, which is data about a present negative pressure ratio relative to the elapsed time at the present stage (in degradation of the performance) of the electric vacuum pump.

Therefore, the OFF timing appropriate for the pump-filling-performance at the present stage (in degradation of the performance) of the electric vacuum pump can be determined.

Thus, the performance of the electric vacuum pump can be improved, and the lifetime of the electric vacuum pump can be extended.

Since the performance of the electric vacuum pump is improved, heavy-duty electric vehicles, such as buses and trucks, with this arrangement can ensure the adequate braking performance of a brake, and can extend the lifetime of the electric vacuum pump. Consequently, this arrangement eliminates the necessity of replacement of an electric vacuum pump for the electric vehicle on regular basis, and thereby can reduce the maintenance costs.

Furthermore, the commercial vehicles with this arrangement, which are electric vehicles with no internal combustion engine, can simultaneously achieve both the pump performance requirement in dispatching and the long lifetime of the pump.

In some embodiments, the pump stop control unit is configured to determine the OFF timing at the present stage of the electric vacuum pump

based on a reference elapsed time t in the reference pump-filling-performance data, wherein the reference elapsed time t is taken from a timing when a pre-OFF threshold is reached after an ON threshold to a timing of a reference OFF threshold, the ON threshold being a negative pressure ratio for activating the electric vacuum pump, the pre-OFF threshold being higher by a predetermined value in the negative pressure ratio than the ON threshold, and

by referring to an elapsed time t in the present pump-filling-performance data, wherein the elapsed time t is substantially the same as the reference elapsed time t in the reference pump-filling-performance data, the elapsed time t being taken from a timing when the pre-OFF threshold is reached after the ON threshold, the ON threshold being a negative pressure ratio for activating the electric vacuum pump, the pre-OFF threshold being higher by the predetermined value in the negative pressure ratio than the ON threshold.

In some embodiments, the pump stop control step determines the OFF timing at the present stage of the electric vacuum pump

based on a reference elapsed time t in the reference pump-filling-performance data, wherein the reference elapsed time t is taken from a timing when a pre-OFF threshold is reached after an ON threshold to a timing of a reference OFF threshold, the ON threshold being a negative pressure ratio for activating the electric vacuum pump, the pre-OFF threshold being higher by a predetermined value in the negative pressure ratio than the ON threshold, and

by referring to an elapsed time t in the present pump-filling-performance data, wherein the elapsed time t is substantially the same as the reference elapsed time t in the reference pump-filling-performance data, the elapsed time t being taken from a timing when the pre-OFF threshold is reached after the ON threshold, the ON threshold being a negative pressure ratio for activating the electric vacuum pump, the pre-OFF threshold being higher by the predetermined value in the negative pressure ratio than the ON threshold.

With this arrangement, the OFF timing at the present stage of the electric vacuum pump is determined by referring to the elapsed time t in the present pump-filling-performance data at the present stage (in degradation of the performance) of the electric vacuum pump. The elapsed time t is substantially the same as the reference elapsed time t in the reference pump-filling-performance data at the initial stage (in dispatching) of the electric vacuum pump; this elapsed time t is taken from a timing when the pre-OFF threshold is reached after the ON threshold which is a negative pressure ratio for activating the electric vacuum pump. Here, the pre-OFF threshold is higher by the predetermined value in the negative pressure ratio than the ON threshold.

Therefore, the OFF threshold at the present stage (in degradation of the performance) of the electric vacuum pump can be decreased, compared to a conventional control method for an electric vacuum pump.

Furthermore, the time required to reach the OFF threshold at the present stage (in degradation of the performance) of the electric vacuum pump can be shortened, compared to the conventional control method for an electric vacuum pump.

Thus, the performance of the electric vacuum pump can be improved, and the lifetime of the electric vacuum pump can be extended.

In this case, when focusing on the performance of a new car, the lifetime of the electric vacuum pump becomes longer than that by the conventional control method for an electric vacuum pump.

Furthermore, in this case, particularly, when focusing on the pump lifetime, the negative pressure ratio at the initial stage (in dispatching) of the electric vacuum pump can be set higher, compared to the conventional control method for an electric vacuum pump.

Since the performance of the electric vacuum pump is improved, heavy-duty electric vehicles, such as buses and trucks, with this arrangement can ensure the adequate braking performance of a brake, and can extend the lifetime of the electric vacuum pump. Consequently, this arrangement eliminates the necessity of replacement of an electric vacuum pump for the electric vehicle on regular basis, and thereby can reduce the maintenance costs.

Furthermore, the commercial vehicles with this arrangement, which are electric vehicles with no internal combustion engine, can simultaneously achieve both the pump performance requirement in dispatching and the long lifetime of the pump.

In some embodiments, the pump stop control unit is configured to determine the OFF timing at the present stage of the electric vacuum pump

by referring to a timing when a derivative ΔP1/ΔT1 in the reference pump-filling-performance data becomes equal to a derivative ΔP2/ΔT2 in the present pump-filling-performance data,

where in the reference pump-filling-performance data, ΔP1 is an increase in the reference negative pressure ratio, and ΔT1 is a time from a timing when a reference pre-OFF threshold is reached to a timing when a reference OFF threshold is reached, the reference pre-OFF threshold being a negative pressure ratio for activating the electric vacuum pump, the reference OFF threshold being a negative pressure ratio for stopping the electric vacuum pump, and where in the present pump-filling-performance data, ΔP2 is an increase in the present negative pressure ratio, and ΔT2 is a time from a timing when a pre-OFF threshold is reached to a timing when an OFF threshold is reached, the pre-OFF threshold being a negative pressure ratio for activating the electric vacuum pump, the OFF threshold being a negative pressure ratio for stopping the electric vacuum pump.

In some embodiments, the pump stop control step determines the OFF timing at the present stage of the electric vacuum pump

by referring to a timing when a derivative ΔP1/ΔT1 in the reference pump-filling-performance data becomes equal to a derivative ΔP2/ΔT2 in the present pump-filling-performance data,

where in the reference pump-filling-performance data, ΔP1 is an increase in the reference negative pressure ratio, and ΔT1 is a time from a timing when a reference pre-OFF threshold is reached to a timing when a reference OFF threshold is reached, the reference pre-OFF threshold being a negative pressure ratio for activating the electric vacuum pump, the reference OFF threshold being a negative pressure ratio for stopping the electric vacuum pump, and

where in the present pump-filling-performance data, ΔP2 is an increase in the present negative pressure ratio, and ΔT2 is a time from a timing when a pre-OFF threshold is reached to a timing when an OFF threshold is reached, the pre-OFF threshold being a negative pressure ratio for activating the electric vacuum pump, the OFF threshold being a negative pressure ratio for stopping the electric vacuum pump.

With this arrangement, the OFF timing at the present stage of the electric vacuum pump is determined by the derivative control. Specifically, the derivative control is executed by referring to the timing when the derivative ΔP2/ΔT2 in the present pump-filling-performance data at the present stage (in degradation of the performance) of the electric vacuum pump becomes equal to the derivative ΔP1/ΔT1 in the reference pump-filling-performance data at the initial stage (in dispatching) of the electric vacuum pump, where ΔT2 is the time up to the OFF threshold and ΔP2 is the increase in the present negative pressure ratio, whereas ΔT1 is the time up to the reference OFF threshold and ΔP1 is the increase in the reference negative pressure ratio.

Therefore, the OFF threshold at the present stage (in degradation of the performance) of the electric vacuum pump can be decreased, compared to a conventional control method for an electric vacuum pump.

Furthermore, the time required to reach the OFF threshold at the present stage (in degradation of the performance) of the electric vacuum pump can be shortened, compared to the conventional control method for an electric vacuum pump.

Thus, the performance of the electric vacuum pump can be improved, and the lifetime of the electric vacuum pump can be extended.

In this case, when focusing on the performance of a new car, the lifetime of the electric vacuum pump becomes longer than that by the conventional control method for an electric vacuum pump.

Furthermore, in this case, when focusing on the pump lifetime, the negative pressure ratio at the initial stage (in dispatching) of the electric vacuum pump can be set higher, compared to the conventional control method for an electric vacuum pump.

Since the performance of the electric vacuum pump is improved, heavy-duty electric vehicles, such as buses and trucks, with this arrangement can ensure the adequate braking performance of a brake, and can extend the lifetime of the electric vacuum pump. Consequently, this arrangement eliminates the necessity of replacement of an electric vacuum pump for the electric vehicle on regular basis, and thereby can reduce the maintenance costs.

Furthermore, the commercial vehicles with this arrangement, which are electric vehicles with no internal combustion engine, can simultaneously achieve both the pump performance requirement in dispatching and the long lifetime of the pump.

In some embodiments, the pump stop control unit is configured to determine the OFF timing at the present stage of the electric vacuum pump

by referring to a timing when an integral of ΔT1 and ΔP1 in the reference pump-filling-performance data becomes equal to an integral of ΔT2 and ΔP2 in the present pump-filling-performance data, wherein the integral of ΔT1 and ΔP1 is given by formula 1, and the integral of ΔT2 and ΔP2 is given by formula 2:

$${\sum }_{i = 1}^{n} P 1 i * \frac{Δ T 1}{n} \qquad [ Formula 1 ]$$

where in the reference pump-filling-performance data, ΔP1 is an increase in the reference negative pressure ratio, and ΔT1 is a time from a timing when a reference pre-OFF threshold is reached to a timing when a reference OFF threshold is reached, the reference pre-OFF threshold being a negative pressure ratio for activating the electric vacuum pump, the reference OFF threshold being a negative pressure ratio for stopping the electric vacuum pump, and

$${\sum }_{i = 1}^{n} P 2 i * \frac{Δ T 2}{n} \qquad [ Formula 2 ]$$

where in the present pump-filling-performance data, ΔP2 is an increase in the present negative pressure ratio, and ΔT2 is a time from a timing when a pre-OFF threshold is reached to a timing when an OFF threshold is reached, the pre-OFF threshold being a negative pressure ratio for activating the electric vacuum pump, the OFF threshold being a negative pressure ratio for stopping the electric vacuum pump.

In some embodiments, the pump stop control step determines the OFF timing at the present stage of the electric vacuum pump

by referring to a timing when an integral of ΔT1 and ΔP1 in the reference pump-filling-performance data becomes equal to an integral of ΔT2 and ΔP2 in the present pump-filling-performance data, wherein the integral of ΔT1 and ΔP1 is given by formula 3, and the integral of ΔT2 and ΔP2 is given by formula 4:

$${\sum }_{i = 1}^{n} P 1 i * \frac{Δ T 1}{n} \qquad [ Formula 3 ]$$

where in the reference pump-filling-performance data, ΔP1 is an increase in the reference negative pressure ratio, and ΔT1 is a time from a timing when a reference pre-OFF threshold is reached to a timing when a reference OFF threshold is reached, the reference pre-OFF threshold being a negative pressure ratio for activating the electric vacuum pump, the reference OFF threshold being a negative pressure ratio for stopping the electric vacuum pump, and

$${\sum }_{i = 1}^{n} P 2 i * \frac{Δ T 2}{n} \qquad [ Formula 4 ]$$

where in the present pump-filling-performance data, ΔP2 is an increase in the present negative pressure ratio, and ΔT2 is a time from a timing when a pre-OFF threshold is reached to a timing when an OFF threshold is reached, the pre-OFF threshold being a negative pressure ratio for activating the electric vacuum pump, the OFF threshold being a negative pressure ratio for stopping the electric vacuum pump.

With this arrangement, the OFF timing at the present stage of the electric vacuum pump is determined by the integral control. Specifically, the integral control is executed by referring to the timing when the integral of the time ΔT2 and the increase ΔP2 in the present pump-filling-performance data at the present stage (in degradation of the performance) of the electric vacuum pump becomes equal to the integral of the time ΔT1 and the increase ΔP1 in the reference pump-filling-performance data at the initial stage (in dispatching) of the electric vacuum pump, where ΔT2 is the time up to the OFF threshold and ΔP2 is the increase in the present negative pressure ratio, whereas ΔT1 is the time up to the reference OFF threshold and ΔP1 is the increase in the reference negative pressure ratio.

Therefore, the OFF threshold at the present stage (in degradation of the performance) of the electric vacuum pump can be decreased, compared to a conventional control method for an electric vacuum pump.

Furthermore, the time required to reach the OFF threshold at the present stage (in degradation of the performance) of the electric vacuum pump can be shortened, compared to the conventional control method for an electric vacuum pump.

Thus, the performance of the electric vacuum pump can be improved, and the lifetime of the electric vacuum pump can be extended.

In this case, particularly, when focusing on the performance of a new car, the lifetime of the electric vacuum pump becomes longer than that by the conventional control method for an electric vacuum pump.

Furthermore, in this case, when focusing on the pump lifetime, the negative pressure ratio at the initial stage (in dispatching) of the electric vacuum pump can be set higher, compared to the conventional control method for an electric vacuum pump.

Since the performance of the electric vacuum pump is improved, heavy-duty electric vehicles, such as buses and trucks, with this arrangement can ensure the adequate braking performance of a brake, and can extend the lifetime of the electric vacuum pump. Consequently, this arrangement eliminates the necessity of replacement of an electric vacuum pump for the electric vehicle on regular basis, and thereby can reduce the maintenance costs.

Furthermore, the commercial vehicles with this arrangement, which are electric vehicles with no internal combustion engine, can simultaneously achieve both the pump performance requirement in dispatching and the long lifetime of the pump.

In some embodiments, the pump stop control unit is configured to determine the OFF timing at the present stage of the electric vacuum pump by referring to a timing when an OFF threshold, which is a negative pressure ratio for stopping the electric vacuum pump, in the present pump-filling-performance data is set to be lower by a predetermined value than a reference OFF threshold, which is a negative pressure ratio for stopping the electric vacuum pump, in the reference pump-filling-performance data.

In some embodiments, the pump stop control step determines the OFF timing at the present stage of the electric vacuum pump

by referring to a timing when an OFF threshold, which is a negative pressure ratio for stopping the electric vacuum pump, in the present pump-filling-performance data is set to be lower by a predetermined value than a reference OFF threshold, which is a negative pressure ratio for stopping the electric vacuum pump, in the reference pump-filling-performance data.

With this arrangement, the OFF timing at the present stage of the electric vacuum pump may be determined by referring to the timing when the OFF threshold, which is the negative pressure ratio for stopping the electric vacuum pump in the present pump-filling-performance data at the present stage (in degradation of the performance) of the electric vacuum pump is lower by the predetermined value than the reference OFF threshold, which is the negative pressure ratio for stopping the electric vacuum pump in the reference pump-filling-performance data at the initial stage (in dispatching) of the electric vacuum pump.

In some embodiments, the control device for the electric vacuum pump is a control device for an electric vacuum pump designed for a brake in a commercial vehicle, which is an electric vehicle with no internal combustion engine.

In some embodiments, the method for controlling an electric vacuum pump is a control method for an electric vacuum pump for a brake in a commercial vehicle, which is an electric vehicle with no internal combustion engine.

Since the control device or method can be applied to the electric vacuum pump for the brake of the commercial vehicle as the electric vehicle, thereby improving the performance of the electric vacuum pump, heavy-duty electric vehicles, such as buses and trucks, with this arrangement can ensure the adequate braking performance of the brake, and can extend the lifetime of the electric vacuum pump. Consequently, this arrangement eliminates the necessity of replacement of an electric vacuum pump for the electric vehicle on regular basis, and thereby can reduce the maintenance costs.

Furthermore, the commercial vehicles with this arrangement, which are electric vehicles with no internal combustion engine, can simultaneously achieve both the pump performance requirement in dispatching and the long lifetime of the pump.

According to at least one embodiment of the present invention, the OFF timing at the present stage of the electric vacuum pump is determined based on the reference pump-filling-performance data, which is data about the reference negative pressure ratio relative to the elapsed time at the initial stage (in dispatching) of the electric vacuum pump, and by referring to the present pump-filling-performance data, which is data about the present negative pressure ratio relative to the elapsed time at the present stage of the electric vacuum pump.

Therefore, the OFF timing appropriate for the pump-filling-performance at the present stage (in degradation of the performance) of the electric vacuum pump can be determined.

Thus, the performance of the electric vacuum pump can be improved, and the lifetime of the electric vacuum pump can be extended.

Since the performance of the electric vacuum pump is improved, heavy-duty electric vehicles, such as buses and trucks, with this arrangement can ensure the adequate braking performance of the brake, and can extend the lifetime of the electric vacuum pump. Consequently, this arrangement eliminates the necessity of replacement of an electric vacuum pump for the electric vehicle on regular basis, and thereby can reduce the maintenance costs.

Furthermore, the commercial vehicles with this arrangement, which are electric vehicles with no internal combustion engine, can simultaneously achieve both the pump performance requirement in dispatching and the long lifetime of the pump.

### BRIEF DESCRIPTION OF THE DRAWINGS

FIG. 1 is a schematic diagram of an entire brake system in which a control device for an electric vacuum pump according to the present invention is applied to a brake of a commercial vehicle, which is an electric vehicle with no internal combustion engine.

FIG. 2 is a partially schematic diagram of the brake system shown in FIG. 1.

FIG. 3 is a graph for explaining the control device for an electric vacuum pump and a method for controlling an electric vacuum pump in an example of the invention, while showing a pump-filling-performance diagram that represents pump-filling-performance data indicative of the relationship between a filling time and a negative pressure ratio in the electric vacuum pump.

FIG. 4 is a partially enlarged graph showing the graph shown in FIG. 3.

FIGS. 5A and 5B are graphs showing the effects exhibited when focusing on the performance of a new car.

FIGS. 6A and 6B are graphs showing the effects exhibited when focusing on a pump lifetime.

FIG. 7 is a graph for explaining the control device for an electric vacuum pump and a method for controlling the electric vacuum pump in another example of the invention, while showing a pump-filling-performance diagram that represents pump-filling-performance data indicative of the relationship between a filling time and a negative pressure ratio in the electric vacuum pump.

FIG. 8 is a partially enlarged graph showing the graph shown in FIG. 7.

FIG. 9 is a graph for explaining the control device for an electric vacuum pump and a method for controlling an electric vacuum pump in a further example of the invention, while showing a pump-filling-performance diagram that represents pump-filling-performance data indicative of the relationship between a filling time and a negative pressure ratio in the electric vacuum pump.

FIG. 10 is a partially enlarged graph showing the graph shown in FIG. 9.

FIG. 11 is a table showing evaluation results on (A) new-car performance, (B) pump lifetime, (C) noise influence, (D) sensor accuracy, and (E) threshold variation adjustment by using simulations.

FIG. 12 is a graph showing the result on (A) new-car performance.

FIG. 13 is a graph showing the result on (B) pump lifetime.

FIG. 14 is a graph showing the result on (C) noise influence.

FIG. 15 is a graph showing the result on (D) sensor accuracy.

FIG. 16 is a graph showing (E) threshold variation adjustment.

FIG. 17 is a graph showing a change in the negative pressure ratio by one brake operation in a conventional automobile including an internal combustion engine, such as the engine.

FIG. 18 is a graph showing a pump-filling-performance diagram that represents pump-filling-performance data indicative of the relationship between a filling time and a negative pressure ratio in a mega pump.

FIG. 19 is a graph showing a change in the negative pressure ratio by one brake operation in a conventional control method for an electric vacuum pump in an electric vehicle.

FIG. 20 is a graph showing a pump-filling-performance diagram that represents pump-filling-performance data indicative of the relationship between a filling time and a negative pressure ratio in an electric vacuum pump.

### DETAILED DESCRIPTION OF THE INVENTION

Embodiments (examples) of the present invention will be described in detail below with reference to the accompanying drawings.

Note that the dimension, material, shape, relative arrangements, and the like of components described in the embodiments or shown in the figures are not intended to limit the scope of the present invention and are illustrative examples only.

For instance, the expressions about equivalent states, including “the same”, “equal”, and “uniform”, indicate not only the equivalent state in the strict sense, but also the states that differ by the tolerance only or to an extent that can achieve the same function. On the other hand, the expressions of “include”, “is provided with”, “is equipped with”, “contain”, and “have” for one component are not exclusive expressions that exclude the presence of other components.

### Example 1

Conventionally, a vehicle, such as an automobile, equipped with an internal combustion engine, for example, an engine, is generally designed to drive a vacuum pump (mega pump) by a rotational driving force produced by the engine, as disclosed in Patent Document 1 (Japanese Unexamined Patent Application Publication No. 2003-102146).

This mechanism generates a negative pressure for a brake booster that assists in reducing a driver's brake operating force and serves as a boosting device for a brake.

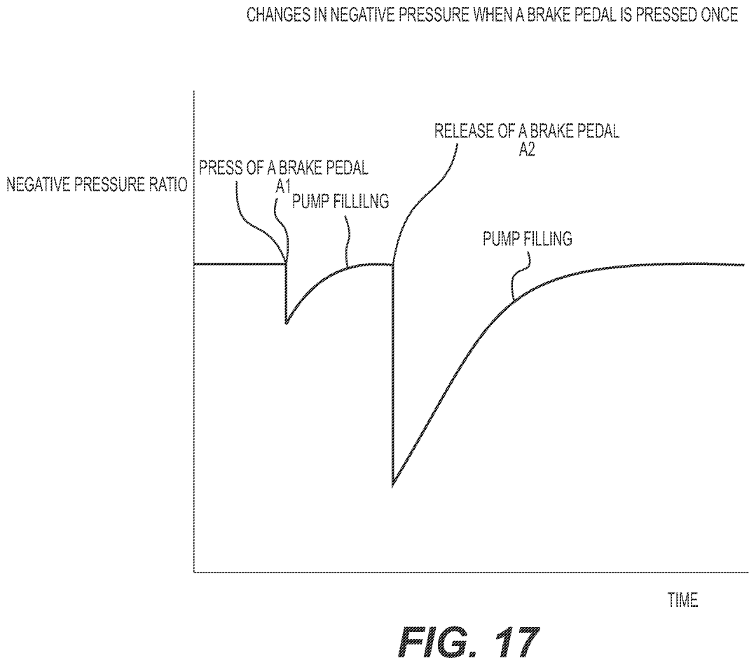

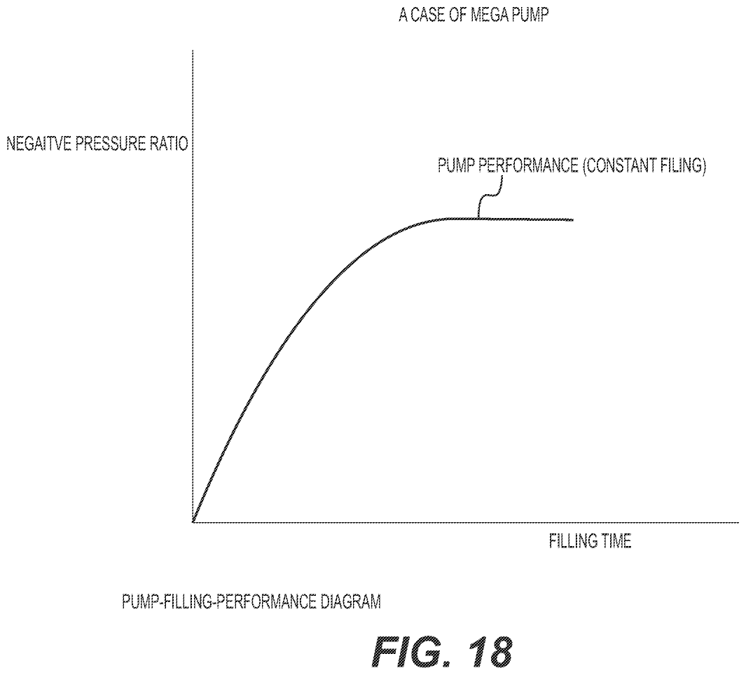

FIG. 17 is a graph showing a change in the negative pressure ratio by one brake operation in a conventional automobile that includes the internal combustion engine, such as the engine. FIG. 18 is a graph showing a pump-filling-performance diagram that represents pump-filling-performance data indicative of the relationship between a filling time and a negative pressure ratio in a mega pump.

That is, as shown in FIG. 17, when a brake pedal is pressed at timing A1, the negative pressure ratio of a brake booster is temporarily decreased, and then by pump filling (filling of the negative pressure by the use of the pump), the negative pressure ratio is increased. At timing A2, the brake pedal is released to further decrease the negative pressure ratio of the brake booster.

Thus, by further pump filling (filling of the negative pressure by the use of the pump), the negative pressure ratio is configured to rise up to the initial state (brake standby state).

At this time, as shown in FIG. 18, the mega pump is constantly driven by the rotational driving force produced by the engine.

Meanwhile, in recent years, electric vehicles have been widely used in terms of limited resources, environment-friendliness, etc. Such an electric vehicle, which has no internal combustion engine, is not provided with a mega pump that uses the rotation of the engine. Thus, to generate a negative pressure in the brake booster, it is necessary to provide an electric vacuum pump dedicated to electric vehicles, in place of the mega pump.

In this case, an electric motor that configures part of the electric vacuum pump has a limited lifetime due to wear and damage of a rotational part and the like, such as a brush. For this reason, the electric motor of the electric vacuum pump cannot be operated constantly, unlike the mega pump.

Therefore, a control method has been conventionally performed on this kind of electric vacuum pump. Specifically, in the control method, under a certain negative pressure (negative pressure ratio), an ON threshold for activating the electric vacuum pump is set. On the other hand, once the predetermined negative pressure (negative pressure ratio) is reached, a threshold (OFF threshold) for stopping the electric vacuum pump is set. In this way, an operating time for the electric vacuum pump is shortened. Measures are taken to delay the degradation of the electric vacuum pump to thereby extend the lifetime thereof.

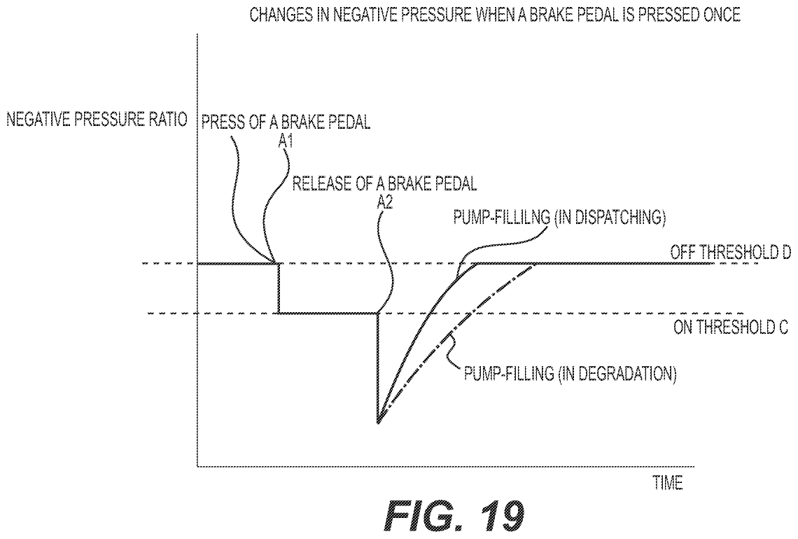

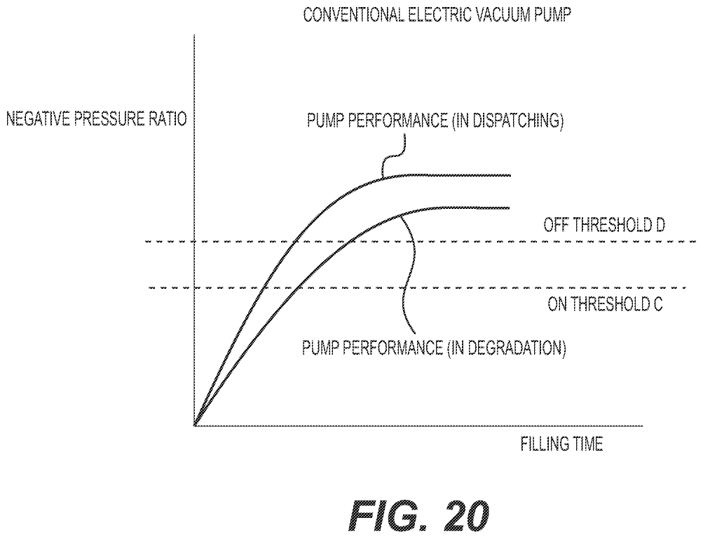

FIG. 19 is a graph showing a change in the negative pressure ratio by one brake operation in the conventional control method for an electric vacuum pump in an electric vehicle. FIG. 20 is a graph showing a pump-filling-performance diagram that represents pump-filling-performance data indicative of the relationship between a filling time and a negative pressure ratio in the electric vacuum pump.

That is, as illustrated in FIGS. 19 and 20, in the conventional control method for an electric vacuum pump in an electric vehicle, under a predetermined negative pressure (negative pressure ratio), the ON threshold C for activating the electric vacuum pump is set. On the other hand, once the predetermined negative pressure (negative pressure ratio) is reached, the threshold (OFF threshold) D for stopping the electric vacuum pump is provided.

In this way, the control method for shortening the operating time of the electric vacuum pump is performed to take measures to delay the degradation of the electric vacuum pump, thereby extending the lifetime thereof.

That is, as shown in FIG. 19, when the brake pedal is pressed at the timing A1, the negative pressure ratio of the brake booster is temporarily decreased. At this time, if the negative pressure ratio of the brake booster becomes under the ON threshold C, the pump filling (filling of the negative pressure by the use of the pump) is started to operate such that the negative pressure ratio of the brake booster becomes the ON threshold.

At the timing A2, the brake pedal is released to further decrease the negative pressure ratio of the brake booster.

Because of this, since the negative pressure ratio of the brake booster becomes under the ON threshold C, the pump filling (filling of the negative pressure by the use of the pump) is performed to increase the negative pressure ratio until a threshold (OFF threshold) D for stopping the electric vacuum pump at the initial state (brake standby state) is reached.

Meanwhile, as shown in FIG. 20, suppose that the OFF threshold D is set at a relatively high negative pressure ratio based on the high pump performance requirement (pump-filling-performance) needed to dispatch a commercial vehicle, such as a truck or a bus. In this case, the operating time might be long at the present stage (in degradation of the performance) of the electric vacuum pump as indicated by alternate long and short dash lines of FIGS. 19 and 20, failing to ensure the sufficient pump lifetime.

Commercial cars, such as trucks and buses, require a relatively higher negative pressure ratio, compared to passenger vehicles.

Thus, when using the electric vacuum pump in such a commercial vehicle, if an OFF threshold is set at a relatively low negative pressure ratio, like a passenger vehicle, in order to achieve the desired long lifetime of an electric vacuum pump, a high pump performance requirement (pump-filling-performance) that is required to dispatch the commercial vehicle cannot be satisfied.

Therefore, when using the electric vacuum pump in a commercial vehicle, there is a trade-off between the achievement of the high pump performance requirement (pump-filling-performance) in dispatching and the extension of the lifetime of the pump, so that both conditions cannot be achieved simultaneously.

In view of the foregoing circumstances, the inventors have diligently studied and consequently invented a control device for an electric vacuum pump and a method for controlling an electric vacuum pump that can extend a lifetime of the electric vacuum pump while improving the performance of the electric vacuum pump.

That is, the inventors have invented the control device for an electric vacuum pump and a method for controlling an electric vacuum pump that can simultaneously achieve both the pump performance requirement in dispatching and the long lifetime of the pump in commercial vehicles, which are electric vehicles with no internal combustion engine.

Now, the control device for an electric vacuum pump and the method for controlling an electric vacuum pump according to an embodiment (example) of the present invention will be described in more detail with reference to the accompanying drawings.

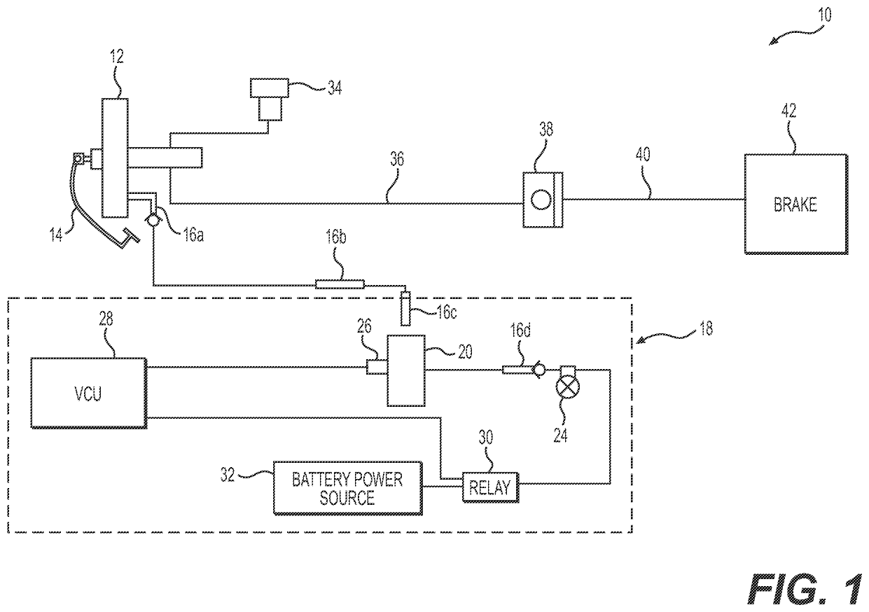

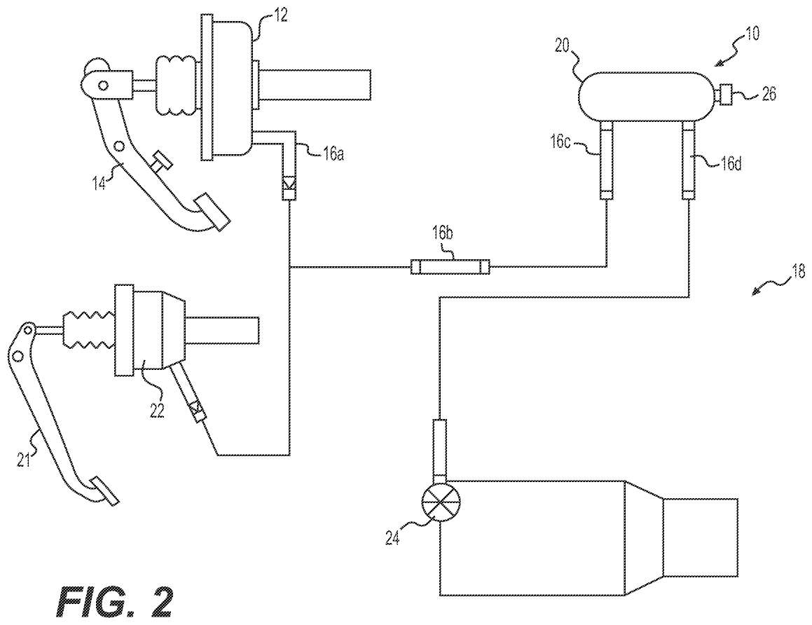

FIG. 1 is a schematic diagram of an entire brake system in which the control device for an electric vacuum pump according to the present invention is applied to a brake of a commercial vehicle, which is an electric vehicle with no internal combustion engine. FIG. 2 is a partially schematic diagram of the brake system shown in FIG. 1.

Referring to FIGS. 1 and 2, reference character 10 denotes an entire brake system to which the control device for an electric vacuum pump in the invention is applied as a whole.

As shown in FIGS. 1 and 2, a brake system 10 includes a brake booster (vacuum booster) 12. A brake pedal 14 is coupled to the brake booster 12.

Note that the brake booster 12 is a device that serves to boost the pressing force of the brake pedal 14 by using a difference between the negative pressure and the atmospheric pressure to thereby reduce the pressing force. In other words, the brake booster 12 configures a brake boosting device that assists in reducing a driver's brake operating force.

The structure of the brake booster 12 is well known in Patent Document 1 (Japanese Unexamined Patent Application Publication No. 2003-102146) and the like, and thus a detailed description of the structure will be omitted in the present specification.

As shown in FIGS. 1 and 2, the brake booster 12 is connected to a vacuum tank 20 that configures a part of a control device 18 for the electric vacuum pump, via a vacuum hose 16a incorporating therein a check valve and vacuum hoses 16b and 16c.

Note that as illustrated in FIG. 2, a clutch booster 22 coupled to a clutch 21 is connected to the vacuum tank 20 in parallel with the brake booster 12 via the vacuum hoses 16b and 16c.

As shown in FIGS. 1 and 2, the vacuum tank 20 is connected to an electric vacuum pump 24 via a vacuum hose 16d that incorporates therein a check valve. As illustrated in FIG. 1, the vacuum tank 20 is provided with a vacuum sensor 26 that is a negative pressure detector for detecting the negative pressure generated by the electric vacuum pump 24.

As shown in FIG. 1, the vacuum sensor 26 of the vacuum tank 20 is connected to a vehicle-control-unit (VCU) 28 that configures a pump stop control unit.

The vehicle-control-unit 28 is connected to the electric vacuum pump 24 via a relay 30. The relay 30 is connected to a battery power source 32 via a fuse box (not shown).

On the other hand, as shown in FIG. 1, the brake booster 12 is connected to a brake fluid tank 34 and further connected to a hydraulic unit 38, such as an Anti-Lock Brake System (ABS), including an engine control unit, via a fluid line 36. The hydraulic unit 38 is connected to brakes 42 positioned on the front, rear, right, and left sides via fluid lines 40.

In the brake system 10 configured in this way, the control device 18 for an electric vacuum pump in this example of the invention is adapted to execute the control in the following manner.

That is, a vehicle-control-unit (VCU) 28 configuring the pump stop control unit is configured to determine an OFF timing at the present stage (in degradation of the performance) of the electric vacuum pump 24 based on reference pump-filling-performance data (a pump-filling-performance diagram) and by referring to present pump-filling-performance data (a pump-filling-performance diagram). The reference pump-filling-performance data is data about a reference negative pressure ratio relative to an elapsed time at the initial stage (in dispatching) of the electric vacuum pump 24. The present pump-filling-performance data is data about a present negative pressure ratio relative to an elapsed time at the present stage (in degradation of the performance) of the electric vacuum pump 24.

That is, in this example, “filling delay-time addition control” is executed in the following way.

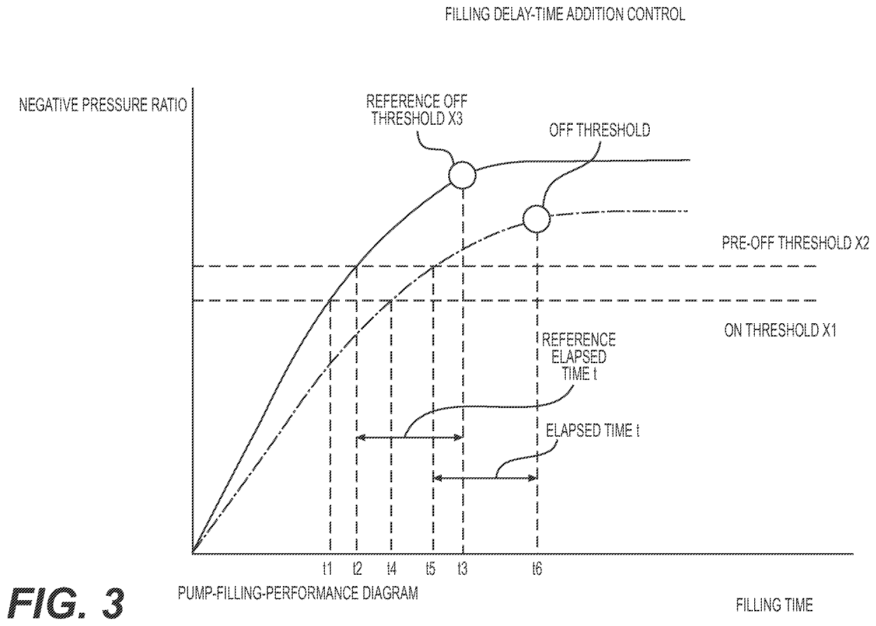

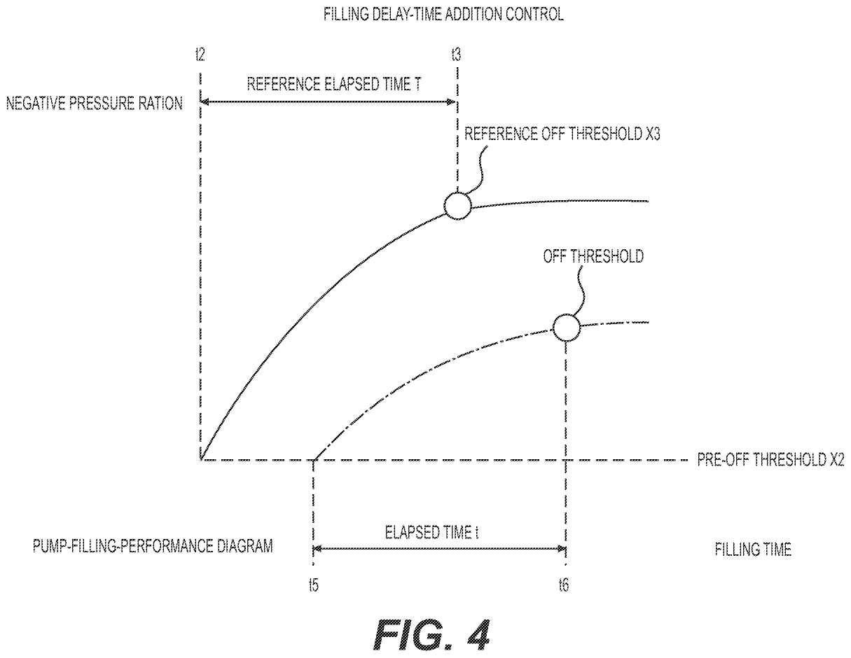

FIG. 3 is a graph for explaining the control device for an electric vacuum pump and the method for controlling an electric vacuum pump in the example of the invention, while showing the pump-filling-performance diagram that represents pump-filling-performance data indicative of the relationship between the filling time and the negative pressure ratio in the electric vacuum pump. FIG. 4 is a partially enlarged graph showing the graph shown in FIG. 3.

That is, in the reference pump-filling-performance data (pump-filling-performance diagram) at the initial stage (in dispatching) of the electric vacuum pump 24 as indicated by the solid line in FIGS. 3 and 4, a pre-OFF threshold X2 is set at timing t2 so as to be higher by a predetermined value of the negative pressure ratio than that at timing t1 when an ON threshold X1 as a negative pressure ratio for activating the electric vacuum pump 24 is reached.

Here, reference elapsed time t is defined as a period of time from a timing of the pre-OFF threshold X2 to timing t3 when a reference OFF threshold X3 is reached.

Furthermore, as indicated by alternate long and short dash lines in FIGS. 3 and 4, in the present pump-filling-performance data (pump-filling-performance diagram) at the present stage (in degradation of the performance) of the electric vacuum pump 24, timing t5 is defined as a timing when a pre-OFF threshold X2 is reached after timing t4 when an ON threshold X1 as a negative pressure ratio for activating the electric vacuum pump 24 is reached. Here, the pre-OFF threshold X2 is higher by a predetermined value of the negative pressure ratio than the ON threshold X1.

Then, timing t6 is determined and defined as the OFF timing (OFF threshold) at the present stage (in degradation of the performance) of the electric vacuum pump 24. Here, the timing t6 is a timing when the same elapsed time t as the reference elapsed time tin the reference pump-filling-performance data at the initial stage (in dispatching) of the electric vacuum pump 24 has been passed since the timing t5 when the pre-OFF threshold X2 is reached.

Note that in this case, the reference pump-filling-performance data (pump-filling-performance diagram) at the initial stage (in dispatching) of the electric vacuum pump 24 and the present pump-filling-performance data (pump-filling-performance diagram) at the present stage (in degradation of the performance) of the electric vacuum pump 24, which are previously measured by measuring equipment, are stored in a memory (not shown). These data are used by the vehicle-control-unit (VCU) 28 configuring the pump stop control unit.

With this arrangement, the “filling delay-time addition control” can lower the OFF threshold at the present stage (in degradation of the performance) of the electric vacuum pump 24, compared to the conventional control method for an electric vacuum pump.

Furthermore, the time required to reach the OFF threshold at the present stage (in degradation of the performance) of the electric vacuum pump 24 can be shortened, compared to the conventional control method for an electric vacuum pump.

Thus, the performance of the electric vacuum pump 24 can be improved, and the lifetime of the electric vacuum pump 24 can be extended.

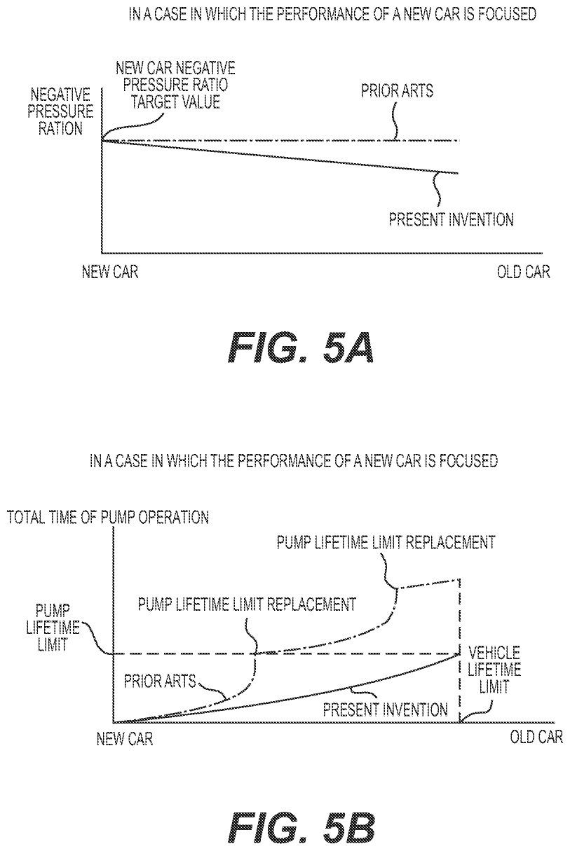

In this case, when focusing on the performance of a new car, as shown in the graphs of FIGS. 5A and 5B, the lifetime of the electric vacuum pump 24 becomes longer than that by the conventional control method for an electric vacuum pump.

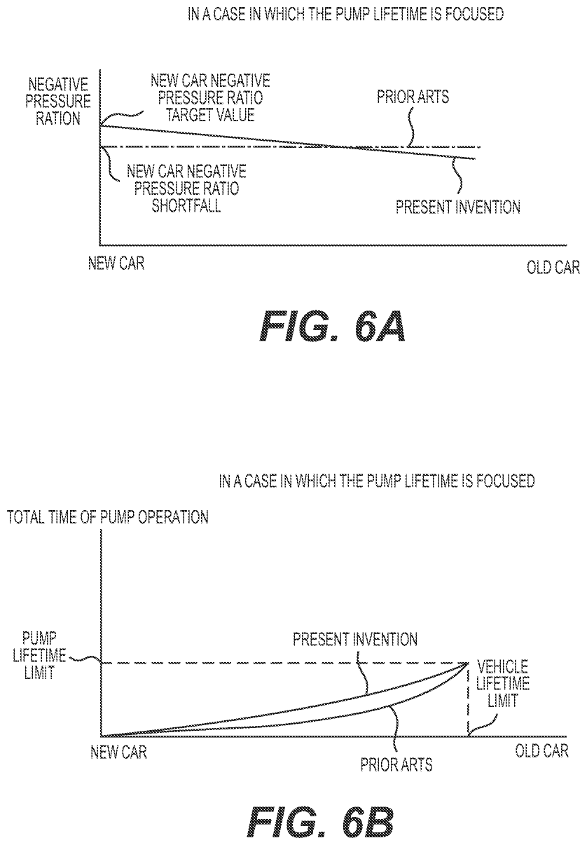

Furthermore, in such a case, as shown in the graphs of FIGS. 6A and 6B, particularly, when focusing on the pump lifetime, the negative pressure ratio at the initial stage (in dispatching) of the electric vacuum pump 24 can be set higher, compared to the conventional control method for an electric vacuum pump.

Since the performance of the electric vacuum pump 24 is improved, heavy-duty electric vehicles, such as buses and trucks, with the arrangement described in this example can ensure the adequate braking performance of the brake, and can extend the lifetime of the electric vacuum pump 24. Consequently, the commercial vehicle with this arrangement can eliminate the necessity of replacement of an electric vacuum pump for the electric vehicle on regular basis, and thereby can reduce the maintenance costs.

Furthermore, the commercial vehicles with this arrangement, which are electric vehicles with no internal combustion engine, can simultaneously achieve both the pump performance requirement in dispatching and the long lifetime of the pump.

### Example 2

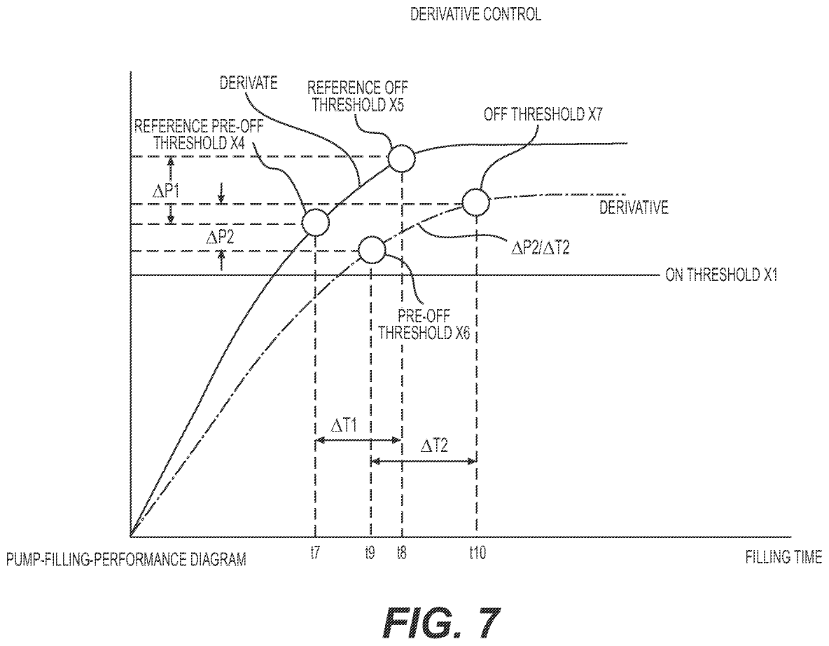

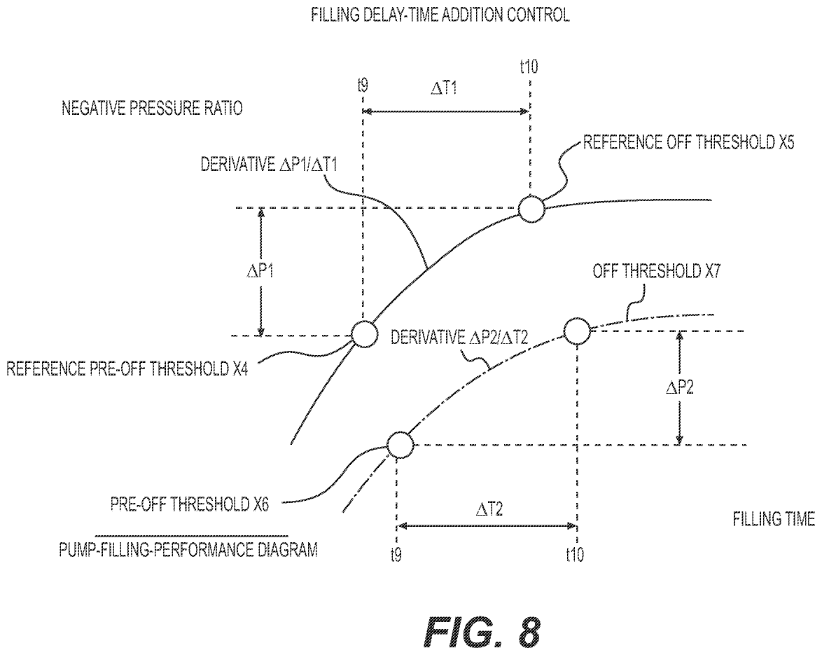

FIG. 7 is a graph for explaining a control device for an electric vacuum pump and a method for controlling an electric vacuum pump in another example of the invention, while showing the pump-filling-performance diagram that represents pump-filling-performance data indicative of the relationship between a filling time and a negative pressure ratio in the electric vacuum pump. FIG. 8 is a partially enlarged graph showing the graph shown in FIG. 7.

That is, in this example, “derivative control” is executed in the following way.

That is, as indicated by the solid line in FIGS. 7 and 8, in the reference pump-filling-performance data at the initial stage (in dispatching) of the electric vacuum pump 24, timing t7 is defined as a timing when the reference pre-OFF threshold X4 as a negative pressure ratio for activating the electric vacuum pump 24 is reached.

The time ΔT1 is defined as the time from the timing t7 when the reference pre-OFF threshold X4 is reached to timing t8 when the reference OFF threshold X5 as a negative pressure ratio for stopping the electric vacuum pump 24 is reached.

An increase ΔP1 in the negative pressure ratio is an increase in the negative pressure ratio caused from the timing t7 when the reference pre-OFF threshold X4 is reached to the timing t8 when the reference OFF threshold X5 as the negative pressure ratio for stopping the electric vacuum pump 24 is reached.

Then, ΔP1/ΔT1 is defined as a derivative of the increase ΔP1 in the negative pressure ratio with respect to the time ΔT1.

Likewise, as indicated by alternate long and short dash lines in FIGS. 7 and 8, in the present pump-filling-performance data at the present stage (in degradation in the performance) of the electric vacuum pump 24, timing t9 is defined as a timing when the pre-OFF threshold X6 as a negative pressure ratio for activating the electric vacuum pump 24 is reached.

The time ΔT2 is defined as the time from the timing t9 when the pre-OFF threshold X6 is reached to timing t10 when the OFF threshold X7 as a negative pressure ratio for stopping the electric vacuum pump 24 is reached.

An increase ΔP2 in the negative pressure ratio is an increase in the negative pressure ratio caused from the timing t9 when the pre-OFF threshold X6 is reached to the timing t10 when the OFF threshold X7 as the negative pressure ratio for stopping the electric vacuum pump 24 is reached.

The timing t10 when the derivative ΔP1/ΔT1 of the increase ΔP1 in the negative pressure ratio with respect to the time ΔT1 is equal to the derivative ΔP2/ΔT2 of the increase ΔP2 in the negative pressure ratio with respect to the time ΔT2 is set as the OFF timing at the present stage (in degradation of the performance) of the electric vacuum pump 24.

With this arrangement, the “derivative control” can lower the OFF threshold at the present stage (in degradation of the performance) of the electric vacuum pump 24, compared to the conventional control method for an electric vacuum pump.

Furthermore, the time required to reach the OFF threshold at the present stage (in degradation of the performance) of the electric vacuum pump 24 can be shortened, compared to the conventional control method for an electric vacuum pump.

Thus, the performance of the electric vacuum pump 24 can be improved, and the lifetime of the electric vacuum pump 24 can be extended.

In this case, when focusing on the performance of a new car, as shown in the graphs of FIGS. 5A and 5B, the lifetime of the electric vacuum pump 24 becomes longer than that by the conventional control method for an electric vacuum pump.

In this case, as shown in the graphs of FIGS. 6A and 6B, particularly, when focusing on the pump lifetime, the negative pressure ratio at the initial stage (in dispatching) of the electric vacuum pump 24 can be set higher, compared to the conventional control method for an electric vacuum pump.

Since the performance of the electric vacuum pump 24 is improved, heavy-duty electric vehicles, such as buses and trucks, with the arrangement described in this example can ensure the adequate braking performance of the brake, and can extend the lifetime of the electric vacuum pump 24. Consequently, this example can eliminate the necessity of replacement of an electric vacuum pump for the electric vehicle on regular basis, and thereby can reduce the maintenance costs.

Furthermore, the commercial vehicles with this arrangement, which are electric vehicles with no internal combustion engine, can simultaneously achieve both the pump performance requirement in dispatching and the long lifetime of the pump.

### Example 3

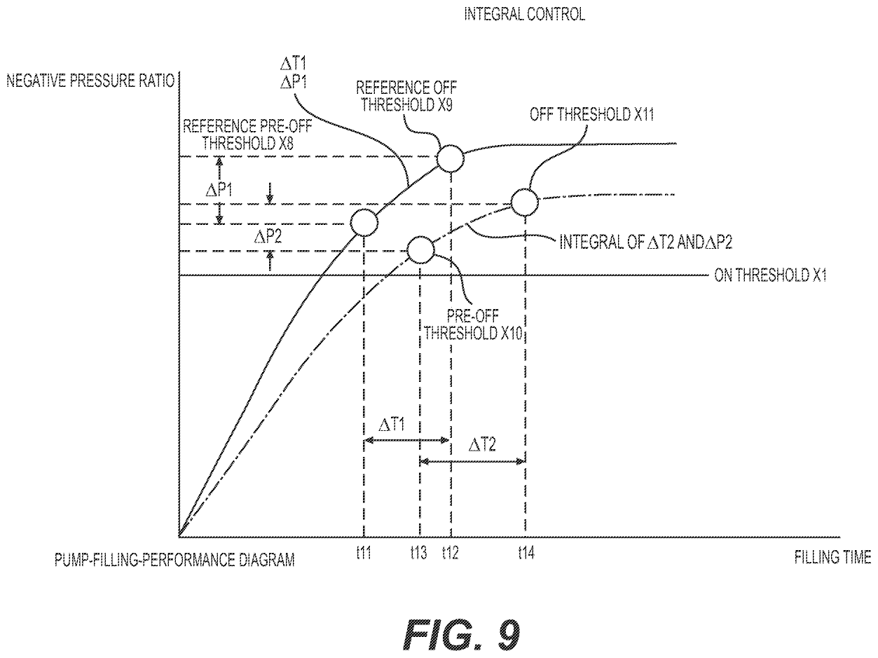

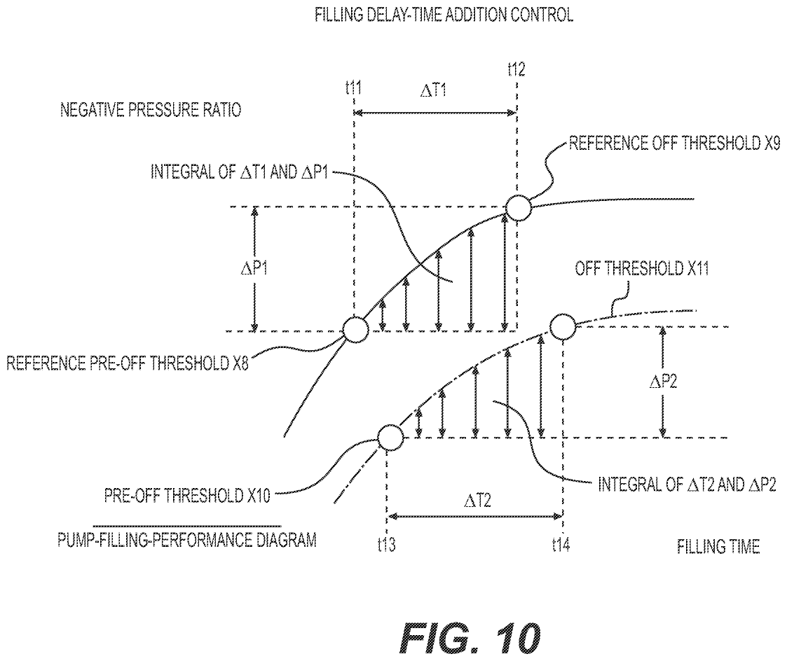

FIG. 9 is a graph for explaining a control device for an electric vacuum pump and a method for controlling an electric vacuum pump in another example of the invention, while showing the pump-filling-performance diagram that represents pump-filling-performance data indicative of the relationship between the filling time and the negative pressure ratio in the electric vacuum pump. FIG. 10 is a partially enlarged graph showing the graph shown in FIG. 9.

That is, in this example, “integral control” is executed in the following way.

That is, as indicated by the solid lines in FIGS. 9 and 10, in the reference pump-filling-performance data at the initial stage (in dispatching) of the electric vacuum pump 24, timing t11 is defined as a timing when the reference pre-OFF threshold X8 as a negative pressure ratio for activating the electric vacuum pump 24 is reached.

The time ΔT1 is defined as the time from the timing t11 when the reference pre-OFF threshold X8 is reached to timing t12 when the reference OFF threshold X9 as a negative pressure ratio for stopping the electric vacuum pump 24 is reached.

An increase ΔP1 in the negative pressure ratio is an increase in the negative pressure ratio caused from the timing t11 when the reference pre-OFF threshold X8 is reached to the timing t12 when the reference OFF threshold X9 as the negative pressure ratio for stopping the electric vacuum pump 24 is reached.

The integral of the time ΔT1 and the increase ΔP1 in the negative pressure ratio is defined by a formula below, where the time ΔT1 is the time up to the reference OFF threshold as the negative pressure ratio for stopping the electric vacuum pump:

$${\sum }_{i = 1}^{n} P 1 i * \frac{Δ T 1}{n} \qquad [ Formula 5 ]$$

Likewise, as indicated by alternate long and short dash lines in FIGS. 9 and 10, in the present pump-filling-performance data at the present stage (in degradation of the performance) of the electric vacuum pump 24, timing t13 is defined as a timing when the pre-OFF threshold X10 as a negative pressure ratio for activating the electric vacuum pump 24 is reached.

The time ΔT2 is defined as the time from the timing t13 when the pre-OFF threshold X10 is reached to timing t14 when the OFF threshold X11 as a negative pressure ratio for stopping the electric vacuum pump 24 is reached.

An increase ΔP2 in the negative pressure ratio is an increase in the negative pressure ratio caused from the timing t13 when the pre-OFF threshold X10 is reached to the timing t14 when the OFF threshold X11 as the negative pressure ratio for stopping the electric vacuum pump 24 is reached.

The integral of the time ΔT2 and the increase ΔP2 in the negative pressure ratio is defined by a formula below, where the time ΔT2 is the time to the OFF threshold as the negative pressure ratio for stopping the electric vacuum pump:

$${\sum }_{i = 1}^{n} P 2 i * \frac{Δ T 2}{n} \qquad [ Formula 6 ]$$

The timing t14 when the integral of the time ΔT1 and the increase ΔP1 in the negative pressure ratio is equal to the integral of the time ΔT2 and the increase ΔP2 in the negative pressure ratio is set as the OFF timing at the present stage (in degradation of the performance) of the electric vacuum pump 24.

With this arrangement, the “integral control” can lower the OFF threshold at the present stage (in degradation of the performance) of the electric vacuum pump 24, compared to the conventional control method for an electric vacuum pump.

Furthermore, the time required to reach the OFF threshold at the present stage (in degradation of the performance) of the electric vacuum pump 24 can be shortened, compared to the conventional control method for an electric vacuum pump.

Thus, the performance of the electric vacuum pump 24 can be improved, and the lifetime of the electric vacuum pump 24 can be extended.

In this case, when focusing on the performance of a new car, as shown in the graphs of FIGS. 5A and 5B, the lifetime of the electric vacuum pump 24 becomes longer than that by the conventional control method for an electric vacuum pump.

In this case, as shown in the graphs of FIGS. 6A and 6B, particularly, when focusing on the pump lifetime, the negative pressure ratio at the initial stage (in dispatching) of the electric vacuum pump 24 can be set higher, compared to the conventional control method for an electric vacuum pump.

Since the performance of the electric vacuum pump 24 is improved, heavy-duty electric vehicles, such as buses or trucks, with the arrangement described in this example can ensure the adequate braking performance of the brake, and can extend the lifetime of the electric vacuum pump 24. Consequently, this example can eliminate the necessity of replacement of an electric vacuum pump for the electric vehicle on regular basis, and thereby can reduce the maintenance costs.

Furthermore, the commercial vehicles with this arrangement, which are electric vehicles with no internal combustion engine, can simultaneously achieve both the pump performance requirement in dispatching and the long lifetime of the pump.

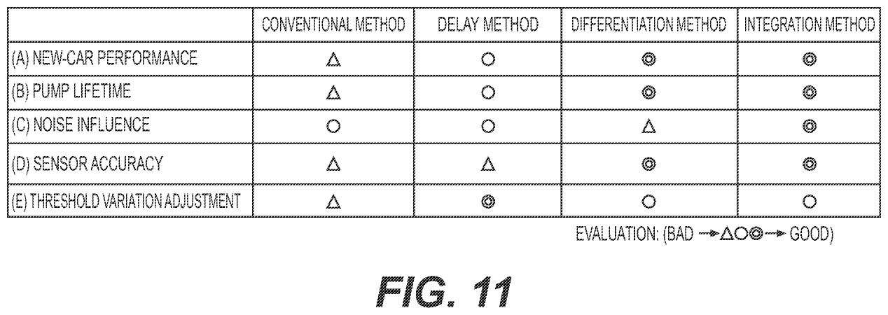

The conventional control method for an electric vacuum pump, the “filling delay-time addition control” in Example 1, the “derivative control” in Example 2, and the “integral control” in Example 3 were respectively evaluated for (A) new-car performance, (B) pump lifetime, (C) noise influence, (D) sensor accuracy, and (E) threshold variation adjustment, by using the respective simulations. The results were shown in a table of FIG. 11.

Note that the simulations were performed under the following conditions:

(A) New-Car Performance . . . Lifetime set constant;
(B) Pump Lifetime . . . New-Car performance set constant;
(C) Noise Influence . . . When strong vibrations occur in a signal
(D) Sensor Accuracy . . . When variations in output from a signal sensor are large (with no vibration)
(E) Threshold Variation Adjustment . . . Flexibility in threshold change adjustment between a new car and an old car

Specifically, the simulations were performed on the condition that the value a is decreased with increasing usage time of the vacuum pump by using formula 7 below:

$${P}_{t} = {aP}_{0} ( 1 - \frac{1}{{e}^{\frac{St}{V}}} ) \qquad [ Formula 7 ]$$

where t is an intake air time (s) from the atmospheric pressure;
P₀ is an atmospheric pressure (Pa);
Pₜ is a negative pressure (Pa) at the time t;
S is a pump intake-air speed (m³/s);
V is a vacuum system volume (m³); and
a is a maximum negative pressure ratio.

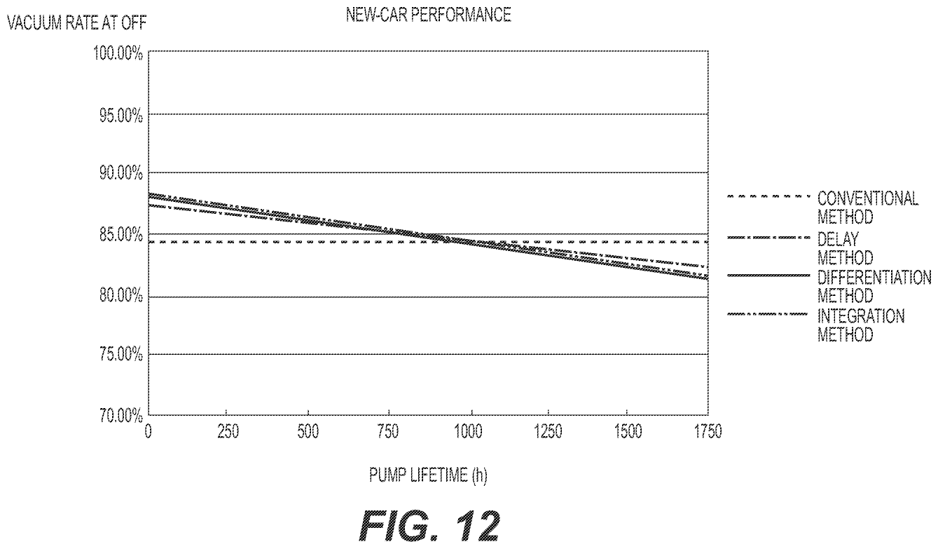

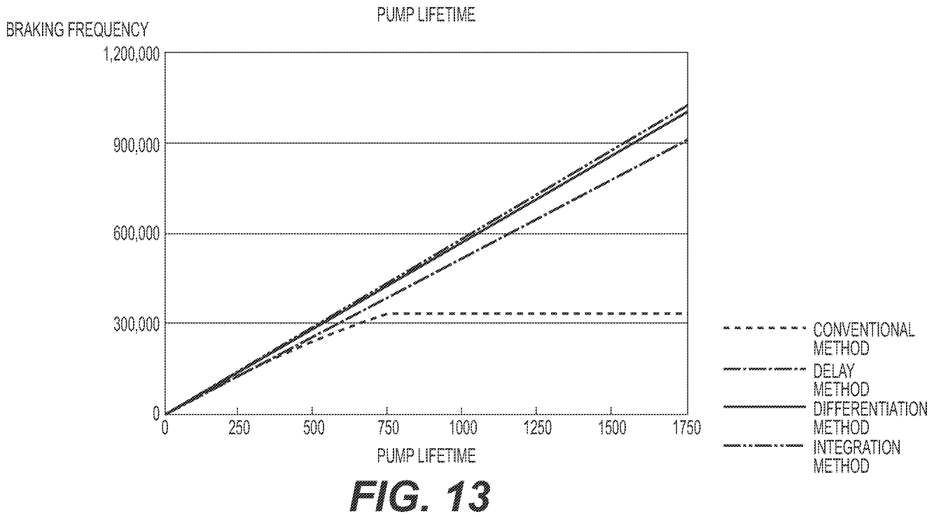

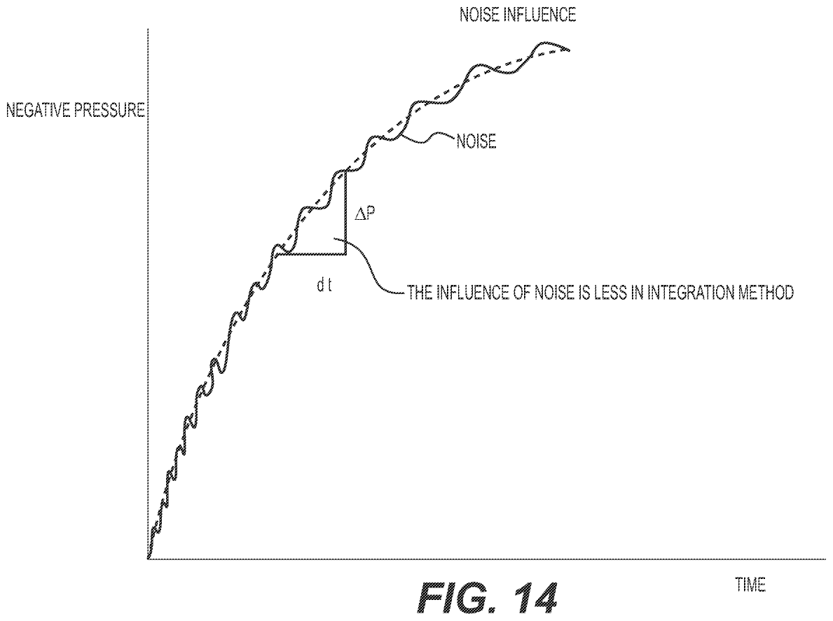

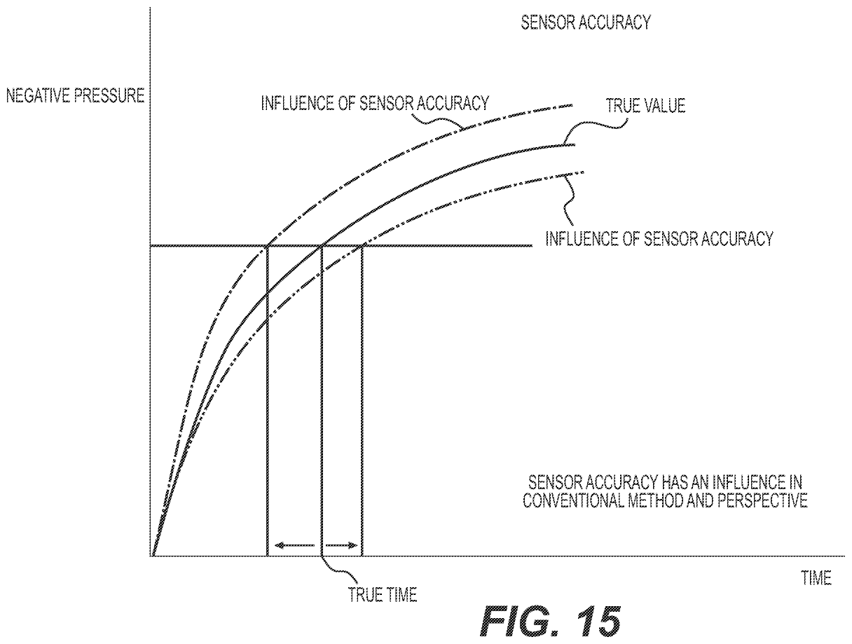

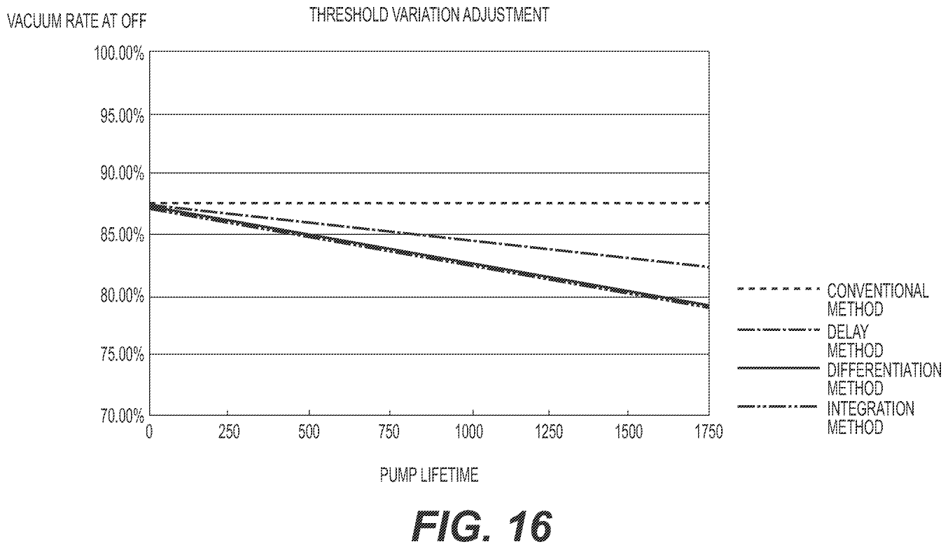

FIG. 12 is a graph showing the result of (A) new-car performance; FIG. 13 is a graph showing the result of (B) pump lifetime; FIG. 14 is a graph showing the result of (C) noise influence; FIG. 15 is a graph showing the result of (D) sensor accuracy; and FIG. 16 is a graph showing the result of (E) threshold variation adjustment.

As indicated by the solid line of the graph indicative of the result of (C) noise influence shown in FIG. 14(C), large vibrations actually occur in the signal due to noise. Because of this, the “integral control” in Example 3 has an advantage over the “derivative control” in Example 2 as it is less likely to be influenced by noise.

As indicated by an alternate long and short dash line and an alternate long and two short dashes line showing the results of (D) sensor accuracy in FIG. 15, the conventional control method for an electric vacuum pump and the “filling delay-time addition control” in Example 1 are influenced by the sensor accuracy.

As can be seen from these results, any of the “filling delay-time addition control” in Example 1, the “derivative control” in Example 2, and the “integral control” in Example 3 according to the present invention is found to improve the characteristics of (A) new-car performance, (B) pump lifetime, (C) noise influence, (D) sensor accuracy, and (E) threshold variation adjustment, compared with the conventional control method for an electric vacuum pump.

When focusing on the new-car performance, the effects exhibited in Examples 1 to 3 become greater in the following orders: the “integral control” in Example 3>the “derivative control” in Example 2; and the “integral control” in Example 3>the “filling delay-time addition control” in Example 1.

When focusing on the pump lifetime, the effects exhibited in Examples 1 to 3 become greater in the following orders: the “filling delay-time addition control” in Example 1>the “derivative control” in Example 2>the “integral control” in Example 3.

Note that in a method (not shown) other than the above methods described in Examples 1 to 3, the OFF timing at the present stage of the electric vacuum pump needs only to be determined by a timing when an OFF threshold is set lower by a predetermined value than a reference OFF threshold. Here, the former OFF threshold is the negative pressure ratio for stopping the electric vacuum pump in the present pump-filling performance data. The reference OFF threshold is the negative pressure ratio for stopping the electric vacuum pump in the reference pump-filling-performance data.

Although the preferred embodiments of the present invention have been described above, the present invention is not limited thereto. For example, as described in the above-mentioned examples, the control device for an electric vacuum pump and the method for controlling an electric vacuum pump in the invention are applied to the brake in a commercial vehicle, which is an electric vehicle with no internal combustion engine. However, such a control device and method for controlling the electric vacuum pump can be additionally applied to not only passenger vehicles, but also electric vehicles, including a hybrid car (HV), a plug-in hybrid car (PHV), a plug-in hybrid electric vehicle (PHEV), and the like.

Furthermore, the control device for an electric vacuum pump and the method for controlling an electric vacuum pump according to the present invention can also be used as control device and control method for an electric vacuum pump in another equipment that uses a negative pressure. In this way, various modifications and changes can be made to the embodiments of the present invention without departing from the object of the present invention.

The present disclosure can be applied to the control device for an electric vacuum pump and the method for controlling the electric vacuum pump.

In more detail, according to the present disclosure, the control device for an electric vacuum pump is provided in a battery pack accommodating therein a cell(s) (a battery) and mounted on a battery-type electric vehicle, such as an electric vehicle (EV), a hybrid car (HV), a plug-in hybrid car (PHV), or a plug-in hybrid electric vehicle (PHEV). The present disclosure can be applied to battery packs that includes an impact detector for detecting the number of impacts, and an impact detection system itself.

1-12. (canceled)

13. A control device for an electric vacuum pump that generates a negative pressure, comprising:
a negative-pressure detector for detecting the negative pressure generated by the electric vacuum pump; and
a pump stop control unit that is configured to stop the electric vacuum pump when the negative pressure detected by the negative-pressure detector is not less than a predetermined value, wherein:
the pump stop control unit is configured to determine an OFF timing at a present stage of the electric vacuum pump
based on reference pump-filling-performance data, which is data about a reference negative pressure ratio relative to an elapsed time at an initial stage of the electric vacuum pump, and
by referring to present pump-filling-performance data, which is data about a present negative pressure ratio relative to an elapsed time at the present stage of the electric vacuum pump.

14. The control device according to claim 13, wherein:
the pump stop control unit is configured to determine the OFF timing at the present stage of the electric vacuum pump
based on a reference elapsed time t in the reference pump-filling-performance data, wherein the reference elapsed time t is taken from a timing when a pre-OFF threshold is reached after an ON threshold to a timing of a reference OFF threshold, the ON threshold being a negative pressure ratio for activating the electric vacuum pump, the pre-OFF threshold being higher by a predetermined increase in the negative pressure ratio than the ON threshold, and
by referring to an elapsed time tin the present pump-filling-performance data, wherein the elapsed time t is substantially a same as the reference elapsed time t in the reference pump-filling-performance data, the elapsed time t being taken from a timing when the pre-OFF threshold is reached after the ON threshold, the ON threshold being a negative pressure ratio for activating the electric vacuum pump, the pre-OFF threshold being higher by the predetermined increase in the negative pressure ratio than the ON threshold.

15. The control device according to claim 13, wherein
the pump stop control unit is configured to determine the OFF timing at the present stage of the electric vacuum pump
by referring to a timing when a derivative ΔP1/ΔT1 in the reference pump-filling-performance data becomes equal to a derivative ΔP2/ΔT2 in the present pump-filling-performance data,
where in the reference pump-filling-performance data, ΔP1 is an increase in the reference negative pressure ratio, and ΔT1 is a time from a timing when a reference pre-OFF threshold is reached to a timing when a reference OFF threshold is reached, the reference pre-OFF threshold being a negative pressure ratio for activating the electric vacuum pump, the reference OFF threshold being a negative pressure ratio for stopping the electric vacuum pump, and
where in the present pump-filling-performance data, ΔP2 is an increase in the present negative pressure ratio, and ΔT2 is a time from a timing when a pre-OFF threshold is reached to a timing when an OFF threshold is reached, the pre-OFF threshold being a negative pressure ratio for activating the electric vacuum pump, the OFF threshold being a negative pressure ratio for stopping the electric vacuum pump.

16. The control device according to claim 13, wherein
the pump stop control unit is configured to determine the OFF timing at the present stage of the electric vacuum pump
by referring to a timing when an integral of ΔT1 and ΔP1 in the reference pump-filling-performance data becomes equal to an integral of ΔT2 and ΔP2 in the present pump-filling-performance data, wherein the integral of ΔT1 and ΔP1 is given by:
$${\sum }_{i = 1}^{n} P 1 i * \frac{Δ T 1}{n}$$
and the integral of ΔT2 and ΔP2 is given by:
$${\sum }_{i = 1}^{n} P 2 i * \frac{Δ T 2}{n}$$
where in the reference pump-filling-performance data, ΔP1 is an increase in the reference negative pressure ratio, and ΔT1 is a time from a timing when a reference pre-OFF threshold is reached to a timing when a reference OFF threshold is reached, the reference pre-OFF threshold being a negative pressure ratio for activating the electric vacuum pump, the reference OFF threshold being a negative pressure ratio for stopping the electric vacuum pump, and
where in the present pump-filling-performance data, ΔP2 is an increase in the present negative pressure ratio, and ΔT2 is a time from a timing when a pre-OFF threshold is reached to a timing when an OFF threshold is reached, the pre-OFF threshold being a negative pressure ratio for activating the electric vacuum pump, the OFF threshold being a negative pressure ratio for stopping the electric vacuum pump.

17. The control device according to claim 13, wherein
the pump stop control unit is configured to determine the OFF timing at the present stage of the electric vacuum pump
by referring to a timing when an OFF threshold, which is a negative pressure ratio for stopping the electric vacuum pump, in the present pump-filling-performance data is set to be lower by a predetermined value than a reference OFF threshold, which is a negative pressure ratio for stopping the electric vacuum pump, in the reference pump-filling-performance data.

18. The control device according to claim 13, wherein
the control device is for an electric vacuum pump for a brake in a commercial vehicle, wherein the commercial vehicle is an electric vehicle without an internal combustion engine.

19. A method for controlling an electric vacuum pump that generates a negative pressure, comprising the steps of:
a negative-pressure detection step of detecting the negative pressure generated by the electric vacuum pump; and
a pump stop control step of stopping the electric vacuum pump when the negative pressure detected by a negative-pressure detector is not less than a predetermined value, wherein
the pump stop control step is adapted to determine an OFF timing at a present stage of the electric vacuum pump
based on reference pump-filling-performance data, which is data about a reference negative pressure ratio relative to an elapsed time at an initial stage of the electric vacuum pump, and
by referring to present pump-filling-performance data, which is data about a present negative pressure ratio relative to an elapsed time at the present stage of the electric vacuum pump.

20. The method according to claim 19, wherein
the pump stop control step determines the OFF timing at the present stage of the electric vacuum pump
based on a reference elapsed time t in the reference pump-filling-performance data, wherein the reference elapsed time t is taken from a timing when a pre-OFF threshold is reached after an ON threshold to a timing of a reference OFF threshold, the ON threshold being a negative pressure ratio for activating the electric vacuum pump, the pre-OFF threshold being higher by a predetermined increase in the negative pressure ratio than the ON threshold, and
by referring to an elapsed time tin the present pump-filling-performance data, wherein the elapsed time t is substantially a same as the reference elapsed time t in the reference pump-filling-performance data, the elapsed time t being taken from a timing when the pre-OFF threshold is reached after the ON threshold, the ON threshold being a negative pressure ratio for activating the electric vacuum pump, the pre-OFF threshold being higher by the predetermined increase in the negative pressure ratio than the ON threshold.

21. The method according to claim 19, wherein
the pump stop control step determines the OFF timing at the present stage of the electric vacuum pump
by referring to a timing when a derivative ΔP1/ΔT1 in the reference pump-filling-performance data becomes equal to a derivative ΔP2/ΔT2 in the present pump-filling-performance data,
where in the reference pump-filling-performance data, ΔP1 is an increase in the reference negative pressure ratio, and ΔT1 is a time from a timing when a reference pre-OFF threshold is reached to a timing when a reference OFF threshold is reached, the reference pre-OFF threshold being a negative pressure ratio for activating the electric vacuum pump, the reference OFF threshold being a negative pressure ratio for stopping the electric vacuum pump, and
where in the present pump-filling-performance data, ΔP2 is an increase in the present negative pressure ratio, and ΔT2 is a time from a timing when a pre-OFF threshold is reached to a timing when an OFF threshold is reached, the pre-OFF threshold being a negative pressure ratio for activating the electric vacuum pump, the OFF threshold being a negative pressure ratio for stopping the electric vacuum pump.

22. The method according to claim 19, wherein
the pump stop control step determines the OFF timing at the present stage of the electric vacuum pump
by referring to a timing when an integral of ΔT1 and ΔP1 in the reference pump-filling-performance data becomes equal to an integral of ΔT2 and ΔP2 in the present pump-filling-performance data, wherein the integral of ΔT1 and ΔP1 is given by:
$${\sum }_{i = 1}^{n} P 1 i * \frac{Δ T 1}{n}$$
and the integral of ΔT2 and ΔP2 is given by:
$${\sum }_{i = 1}^{n} P 2 i * \frac{Δ T 2}{n}$$
where in the reference pump-filling-performance data, ΔP1 is an increase in the reference negative pressure ratio, and ΔT1 is a time from a timing when a reference pre-OFF threshold is reached to a timing when a reference OFF threshold is reached, the reference pre-OFF threshold being a negative pressure ratio for activating the electric vacuum pump, the reference OFF threshold being a negative pressure ratio for stopping the electric vacuum pump, and
where in the present pump-filling-performance data, ΔP2 is an increase in the present negative pressure ratio, and ΔT2 is a time from a timing when a pre-OFF threshold is reached to a timing when an OFF threshold is reached, the pre-OFF threshold being a negative pressure ratio for activating the electric vacuum pump, the OFF threshold being a negative pressure ratio for stopping the electric vacuum pump.

23. The method according to claim 19, wherein
the pump stop control step determines the OFF timing at the present stage of the electric vacuum pump
by referring to a timing when an OFF threshold, which is a negative pressure ratio for stopping the electric vacuum pump, in the present pump-filling-performance data is set to be lower by a predetermined value than a reference OFF threshold, which is a negative pressure ratio for stopping the electric vacuum pump, in the reference pump-filling-performance data.

24. The method according to claim 19, wherein
the electric vacuum pump is for a brake in a commercial vehicle, wherein the commercial vehicle is an electric vehicle without an internal combustion engine.
